(19) United States
(12) Patent Application Publication
(10) Pub. No.: US 2020/0012939 A1
(43) Pub. Date: Jan. 9, 2020

(54) Methods and Apparatus for Visualization Recommender

(71) Applicant: Massachusetts Institute of Technology, Cambridge, MA (US)

(72) Inventors: Kevin Hu, Cambridge, MA (US); Michiel Bakker, Cambridge, MA (US); Cesar Hidalgo, Somerville, MA (US)

(21) Appl. No.: 16/413,575

(22) Filed: May 15, 2019

Related U.S. Application Data
(60) Provisional application No. 62/694,996, filed on Jul. 7, 2018.

(51) Int. Cl. G06N 3/08; G06N 3/04; G06F 16/904

(52) U.S. Cl. CPC G06N 3/08; G06F 16/904; G06N 3/04

(57) ABSTRACT

A neural network may be trained on a training corpus that comprises a large number of dataset-visualization pairs. Each pair in the training corpus may consist of a dataset and a visualization of the dataset. The visualization may be a chart, plot or diagram. In each dataset-visualization pair in the training corpus, the visualization may be created by a human making design choices. The neural network may be trained to predict, for a given dataset, a visualization that a human would create to represent the given dataset. During training, features and design choices may be extracted from the dataset and visualization, respectively, in each dataset-visualization pair in the training corpus. After the neural network is trained, features may be extracted from a new dataset, and the trained neural network may predict design choices that a human would make to create a visualization that represents the new dataset.

### RELATED APPLICATIONS

This application claims the benefit of U.S. Provisional Application No. 62/694,996 filed Jul. 7, 2018 (the “Provisional”).

### FIELD OF TECHNOLOGY

The present invention relates generally to data visualization.

### COMPUTER PROGRAM LISTING

The following 34 computer program files are incorporated by reference herein: (1) agg_py.txt with a size of about 5 KB; (2) aggregate_single_field_features_py.txt with a size of about 3 KB; (3) aggregation_helper_py.txt with a size of about 3 KB; (4) analysis_py.txt with a size of about 14 KB; (5) chart_outcomes_py.txt with a size of about 5 KB; (6) dateparser_py.txt with a size of about 3 KB; (7) deduplicate_charts_py.txt with a size of about 6 KB; (8) deduplication_py.txt with a size of about 2 KB; (9) evaluate_py.txt with a size of about 3 KB; (10) extract_py.txt with a size of about 13 KB; (11) field_encoding_outcomes_py.txt with a size of about 6 KB; (12) general_helpers_py.txt with a size of about 4 KB; (13) helpers_py.txt with a size of about 5 KB; (14) impute_py.txt with a size of about 1 KB; (15) nets_py.txt with a size of about 2 KB; (16) paper_groundtruth_py.txt with a size of about 7 KB; (17) paper tasks_py.txt with a size of about 20 KB; (18) Part_0.txt with a size of about 25 KB; (19) Part_1.txt with a size of about 29 KB; (20) Part_2.txt with a size of about 27 KB; (21) Part_3.txt with a size of about 99 KB; (22) preprocess_py.txt with a size of about 10 KB; (23) processing_py.txt with a size of about 5 KB; (24) remove_charts_without_all_data_py.txt with a size of about 3 KB; (25) requirements_py.txt with a size of about 1 KB; (26) retrieve_data_sh.txt with a size of about 1 KB; (27) save_field_py.txt with a size of about 5 KB; (28) single_field_features_py.txt with a size of about 15 KB; (29) train_field_py.txt with a size of about 11 KB; (30) train_py.txt with a size of about 8 KB; (31) transform_py.txt with a size of about 2 KB; (32) type_detection_py.txt with a size of about 3 KB; (33) util_py.txt with a size of about 3 KB; and (34) util2_py.txt with a size of about 1 KB. Each of these 34 files were created as an ASCII .txt file on Apr. 30, 2019.

### BACKGROUND

Conventional methods exist for automatically generating a visualization (e.g., chart, plot or diagram) to visually represent a dataset. The conventional methods suffer from major drawbacks.

Many conventional methods of automated data visualization are rule-based. These rule-based systems encode visualization guidelines as a collection of “if-then” statements, or rules, to automatically generate visualizations for users to search and select, rather than manually specify. However, these rule-based approaches suffer from at least two drawbacks. First, the complexity and number of the possible results tends to grow exponentially as the number of allowed design choices increases. Put differently, the rule creation suffers from a combinatorial explosion of possible results. Second, rule creation tends to be costly and time-consuming. The cost and time expenditure becomes more problematic as the number of rules increases exponentially.

Some conventional methods of automated data visualization employ machine learning (ML). These conventional ML-based systems have at least two drawbacks. First, they are trained with annotations on rule-generated visualizations in controlled settings. Thus, in these conventional ML-based methods, the training dataset is a highly imperfect proxy for how humans would actually choose to visualize a dataset. Second, generating these annotations on rule-based visualizations tends to be time-consuming and costly. This in turn may make it prohibitively expensive to generate a sufficiently large dataset to train a deep neural network.

### SUMMARY

In illustrative implementations of this invention, a visualization recommender system solves these problems, as discussed in more detail below. We sometimes call this visualization recommender system a “VizML” system.

In illustrative implementations, a neural network is trained on a training corpus that comprises a large number dataset-visualization pairs. Each pair in the training corpus may consist of a dataset and a visualization of the dataset. For instance, in each pair, the visualization may be a chart, plot or diagram that represents the associated dataset by one or more scatterplots, line charts, bar charts, box plots, histograms, or pie charts.

In each dataset-visualization pair in all (or a majority) of the training corpus, the visualization may be created by a human making design choices. For instance, in some cases, each visualization-dataset pair in all (or a majority) of the training corpus was created by a human user who employed Plotly® software: (a) to import or upload a dataset; and (b) to implement design choices that were made by the human user to specify the visualization.

The number of dataset-visualization pairs in the training corpus may be quite large. For instance, in a prototype of this invention, the training corpus included more than a million datasets before data cleaning and more than 100,000 datasets after data cleaning.

The neural network may be trained to predict, for a given dataset, a visualization that a human user would create to represent the given dataset.

During training: (a) features may be extracted from the dataset in each dataset-visualization pair in the training corpus; and (b) design choices may be extracted from the visualization in each data-set visualization pair in the training corpus. For each dataset-visualization pair in the training corpus, the set of features extracted from the dataset may be associated with the design choices extracted from the visualization. A neural network may be trained on the extracted features and extracted design choices.

After the neural network is trained, the trained network may be presented with a new dataset. Features may be extracted from the new dataset. Based on features extracted from the new dataset, the trained neural network may predict a visualization for the new dataset—e.g., may predict a visualization that a human would create for the visualization. Put differently, based on features extracted from the new dataset, the trained neural network may predict a set of design choices that specify a visualization.

The VizML system may present the predicted visualization to the human user as a recommendation. For instance, the VizML system may output instructions that cause the recommended visualization to be displayed by an electronic display screen.

In some cases, the neural network predicts—and the VizML system presents to the user—more than one recommended visualization. The recommended visualizations may be ranked.

In some cases, a VizML system is customized for an individual user. For instance, the VizML system may initially recommend multiple visualizations to a user, and may keep track of which visualizations the user selects, thereby learning the user's preferences. Based on these learned preferences, the VizML system may make customized recommendations of visualizations to the user.

In illustrative implementations, the VizML system solves the problems of conventional visualization recommenders that are discussed in the Background section above.

First, as discussed above, conventional rule-based visualization recommenders employ a complex set of “if-then” rules to make design choices for visualizations. These “if-then” rules for design choices are costly and time-consuming to create and tend to increase exponentially in number as the set of allowed design choices increases. These problems are avoided by the present invention. This is because, in illustrative implementations, the present invention employs a trained neural network, rather than a conventional complex set of “if-then” rules for design choices.

Second, as discussed above, conventional learning (ML)-based visualization recommenders are trained on visualizations that (a) were created automatically a computer performing rule-based “if-then” design choices, and (b) then were annotated by human users. In these conventional systems, these automatically created visualizations are a highly imperfect proxy for what a human would actually create, and thus training on them may lead to poor predictions. Furthermore, creating these annotations is costly and time-consuming, and this in turn tends to cause smaller training datasets to be employed. These problems are avoided by the present invention. This is because, in some implementations of the present invention: (a) each particular visualization in the training corpus (or in a majority of the training corpus) was created by a human who made design choices while creating that particular visualization; (b) the visualizations in the training corpus are not annotated with human-created annotations; and (c) a very large training corpus is employed.

The Summary and Abstract sections and the title of this document: (a) do not limit this invention; (b) are intended only to give a general introduction to some illustrative implementations of this invention; (c) do not describe all of the details of this invention; and (d) merely describe non-limiting examples of this invention. This invention may be implemented in many other ways. Likewise, the Field of Technology section is not limiting; instead it identifies, in a general, non-exclusive manner, a field of technology to which some implementations of this invention generally relate.

### BRIEF DESCRIPTION OF THE DRAWINGS

FIG. 1 is a diagram that illustrates making design choices.

FIG. 2 illustrates hardware of a visualization recommender system.

FIGS. 3 and 6 are each a flowchart for data visualization.

FIG. 4 illustrates features that are extracted from a dataset.

FIG. 5 illustrates design choices that are extracted from a data visualization.

The above Figures are not necessarily drawn to scale. The above Figures show illustrative implementations of this invention, or provide information that relates to those implementations. The examples shown in the above Figures do not limit this invention. This invention may be implemented in many other ways.

### DETAILED DESCRIPTION

### Data Visualization Model

Before discussing details of the present invention, it is helpful to first formulate a model of data visualization.

Visualization of a dataset d may be modeled as a set of interrelated design choices C={c}, each of which is selected from a possibility space c˜ [symbol] . However, not all design choices result in valid visualizations—some choices are incompatible with each other. For instance, encoding a categorical column with the Y position of a line mark is invalid. Therefore, the set of choices that result in valid visualizations is a subset of the space of all possible choices [symbol] ₁× [symbol] ₂× . . . [symbol] _{|C|}.

The effectiveness of a visualization may be affected by informational parameters such as efficiency, accuracy, and memorability, or emotive parameters such as engagement. For instance, effectiveness may depend on low-level perceptual principles and dataset properties, in addition to contextual factors such as task, aesthetics, domain, audience, and medium. It is desirable to make design choices Cₘₐₓ that maximize visualization effectiveness Eff given a dataset d and contextual factors T:

$${C}_{max} = {arg max}_{C} Eff ( C \vert d , T ) \qquad ( Equation 1 )$$

But making design choices may be expensive. A goal of visualization recommendation is to reduce the cost of creating visualizations by automatically suggesting a subset of design choices C_{rec}⊆C.

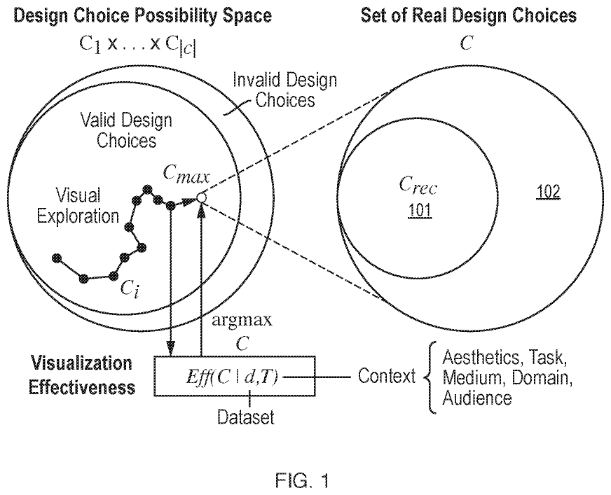

FIG. 1 illustrates making design choices, in an illustrative implementation of this invention. In the example shown in FIG. 1, a set of data visualizations C_{rec} 101 that are recommended by the visualization recommender system is a subset of the set of real design choices C 102.

Consider a single design choice c∈C. Let C′=C\{c} denote the set of all other design choices excluding c. Given C′, a dataset d, and context T, there is an ideal design choice recommendation function F that outputs the design choice Cₘₐₓ∈Cₘₐₓ from Equation 1 that maximizes visualization effectiveness:

F_{c}(d|C′,T)=Cₘₐₓ (Equation 2)

This ideal design choice recommendation function F_{c} may be approximated with a function G_{c}≈F_{c}. Assume now a corpus of datasets D={d} and corresponding visualizations V={V_{d}}, each of which can be described by design choices C_{d}={C_{d}}. A machine learning-based visualization recommender system (in the present invention) may treat G_{c} as a model with a set of parameters Θ_{c} that may be trained on this corpus by a learning algorithm that maximizes an objective function Obj:

$${Θ}_{fit} = {arg max}_{{Θ}_{c}} {\sum }_{d ∈ D} Obj ( {c}_{d} , {G}_{c} , ( d \vert {Θ}_{c} , {C}^{′} , T ) ) \qquad ( Equation 3 )$$

Without loss of generality, let the objective function maximize the likelihood of observing the training output {C_{d}}. Even if sub-optimal design choices are made, collectively optimizing the likelihood of all observed design choices may still be optimal. For instance, the observed design choices may be C_{d}=F_{c}(d|C′,T)+noise+bias. Therefore, given an unseen dataset d*, maximizing this objective function may lead to a recommendation that maximizes effectiveness of a visualization.

G_{c}(d|Θ_{fit},C′,T)≈F_{c}(d*|C′,)=cₘₐₓ (Equation 4)

In the present invention, the model G_{c} may be a neural network and Θ_{c} may be connection weights. The recommendation problem may be simplified by optimizing each G_{c} independently, and without contextual factors: G_{c}(d|Θ)=G_{c}(d|Θ,C′,T).

In some implementations, dependencies between G_{c} are modeled for each c. This in turn may facilitate: (a) avoiding incompatible independent recommendations; and (b) maximizing overall effectiveness of the visualization.

The model of data visualization that is discussed above is a non-limiting example. Other models may be employed with the present invention.

### Visualization Recommender System

In illustrative implementations of this invention, a visualization recommender system (VizML system) employs a neural network to predict one or more data visualizations (e.g., charts, plots, or diagrams) that represent a given dataset. The given dataset (for which the VizML system recommends a visualization) may comprise any type of data. For instance, the VizML system may recommend visualizations that represent weather data, financial data, product data, health data, data regarding any physical phenomena, data regarding human behavior, or any other type of data.

In illustrative implementations, the neural network is trained on a training dataset. We sometimes call the training dataset a training corpus.

The training corpus may comprise a large number of pairs (e.g., more than 100,000 or more than 1,000,000 pairs). Each pair in the training corpus (or in a majority of the training corpus) may consist of a particular dataset and a particular visualization (e.g., chart, plot or diagram) of that particular dataset, which particular visualization was created by a human being who made design choices while creating it. For instance, these design choices (made by a human) may be choices regarding how to visually represent the particular dataset.

In many implementations of this invention, the neural network is trained on a training corpus that includes information about a large number of design choices that humans actually made while creating data visualizations.

In many implementations of this invention: (a) all (or a majority) of the visualizations in the training corpus are not created automatically and solely by software; and (b) the neural network is not trained with human-made annotations on data visualizations.

In some cases, human design choices were made for each specific pair, in a group of pairs that consists of most or all of dataset-visualization pairs in the training corpus. The specific pair may consist of a specific dataset and a specific visualization that visually represents the specific dataset. The specific visualization (e.g., chart, plot or diagram) may have been created by a human who considered the specific dataset and made design choices regarding how to visually represent the specific dataset.

In some cases, a human employed software to input and implement the human's design choices (to create a visualization in the training corpus). For instance, this software may comprise: (a) Plotly® software; (b) Vega-Lite software (or software that employs Vega-Lite grammar); or (c) Tableau® software.

For each dataset-visualization pair in the training corpus, one or more computers may (a) extract features from the dataset in the pair and (b) extract design choices that define the visualization in the pair. These features and design choices (which are extracted from the dataset-visualization pairs in the training corpus) may be employed to train the neural network.

After the neural network is trained, the VizML system: (a) may take a given dataset as an input; and (b) may predict one or more visualizations (e.g., diagrams, plots or charts) that a human user would create to visually represent the given data set.

To do so, one or more computers may extract features from the given dataset. The trained neural network may, based on these features (which were extracted from the given dataset) predict which visualization(s) a human user would create for given dataset. Put differently, the trained neural network may, based on features (that were extracted from a given dataset), predict which set of design choices a human user would make when creating a visualization (e.g., chart, plot or diagram) of the given dataset.

Based on the neural network's predictions, the VizML system may recommend, to a human user, one or more data visualizations that may be employed to represent the given dataset. For instance, the VizML system: (a) may present to the human user a set of one or more visualizations (e.g., charts, diagrams or plots) that each represent the given dataset; and (b) may accept input from the human user, which input either (i) selects a visualization (out of those presented by the VizML system) the human user prefers, or (ii) rejects all of the visualizations that were presented.

In some cases: (a) the VizML system ranks the recommended visualizations (e.g., based on the neural network's prediction regarding visualizations a human user would select); and (b) presents the visualizations in such a way that the ranking is communicated to the human user. For instance, the VizML system may display an ordinal number beside each visualization, to indicate the order in which the visualization is ranked. Or, the VizML system may display the visualizations in a spatial sequence, such as from top to bottom of a display screen or a displayed webpage, where the order of the spatial sequence corresponds to the ranking (e.g., the higher the visualization's position on the display screen or webpage, the higher the ranking). Or, the VizML system may display the visualizations in a temporal sequence, in such a way that temporal order of the sequence corresponds to the ranking (e.g., the earlier that a visualization is displayed, the higher the ranking). Or, for instance, the VizML system may present a graphical user interface that: (a) displays one or more top-ranked visualizations; and (b) displays one or more graphical elements that, when selected by a human user, allow the user to see or scroll through the other low-ranked visualizations.

In many implementations, the VizML system visually displays, or outputs instructions to visually display, one or more recommended data visualizations to a human user. For instance, the VizML system may include an electronic display screen that displays the recommended data visualizations. Or, for instance, the VizML system may output instructions that cause an electronic display system to display the recommended data visualizations.

Alternatively, the VizML system may output data that specifies the recommended data visualizations. For instance, the data (which is outputted by the VizML system) may specify design choices that are included in a particular data visualization. For example, the data may specify high-level design choices (e.g., whether to use a bar chart, box plot, area chart, line chart or scatter plot) or more low-level choices (e.g., whether to represent a particular variable on the x-axis or y-axis). In some cases, the VizML system displays (or outputs instructions to display) this data in humanly perceptible format, such as by displaying, on a graphical user interface, text that specifies design choices. In other cases, the VizML system outputs this data in a format that (a) is not perceptible to unaided human senses, (b) specifies recommended data visualizations, and (c) does not include instructions regarding displaying the information to a user.

In some cases, the neural network is trained on a training corpus that comprises dataset-visualization pairs created by a large number of human users (e.g., more than 10,000 users, or more than 100,000 users).

In many cases, the VizML system's predictions (or recommendations) are not customized for a particular human user.

Alternatively, the VizML system may generate predictions (or recommendations) that are customized for a particular human user. For instance, the VizML system may track a particular user's preferences and may predict or recommend visualizations based, at least to some extent, on these preferences. For example, the VizML system may present to a user multiple visualizations for a given dataset, and may store data regarding which visualization the user selects. The VizML system may do this repeatedly, and thereby acquire data regarding the user's preferences. Initially, the VizML system may predict (or recommend) a visualization based solely on training on a training corpus created by a large number of people. However, after acquiring data regarding preferences of a particular user, the VizML system may take these preferences into account when recommending a visualization to the particular person.

Alternatively, in some cases, the dataset-visualization pairs in the training corpus are associated (e.g. automatically, while creating the pairs) with data regarding the human user who creates the visualization, such as the user's age or sex. Thus, in some cases, the neural network may be trained to predict different visualizations for different classes of persons (e.g., for a class comprising persons in a certain age range, or for a class comprising persons of a particular sex in a particular age range).

A wide variety of neural networks (NNs) may be employed in this invention. In some cases, the NN is fully connected. In some cases, the NN comprises a restricted Boltzmann machine. In some cases, the NN comprises a convolutional neural network (CNN). For instance, the CNN may include one or more convolutional layers, fully connected layers and pooling layers, and may employ ReLU (rectified linear unit) activation functions. In some cases, the neural network comprises a recurrent neural network (RNN) or long short-term memory (LSTM) network. For instance, the RNN may comprise an Elman network, Jordan network, or Hopfield network. Alternatively, any other type of artificial neural network may be employed, including any type of deep learning, supervised learning, or unsupervised learning.

In some implementations, the VizML system includes a graphical user interface (GUI). A human user may, via the GUI, input instructions to upload or import data (e.g., stored in one or more datafiles) that comprises a given dataset. Alternatively, a human user may manually (e.g., with keystrokes) input or edit all or a portion of the given dataset. After the given dataset is received by the VizML system, the VizML system may analyze the given dataset, predict or recommend one or more visualizations that represent the given dataset, and then present the recommended visualizations to a human user, as described above.

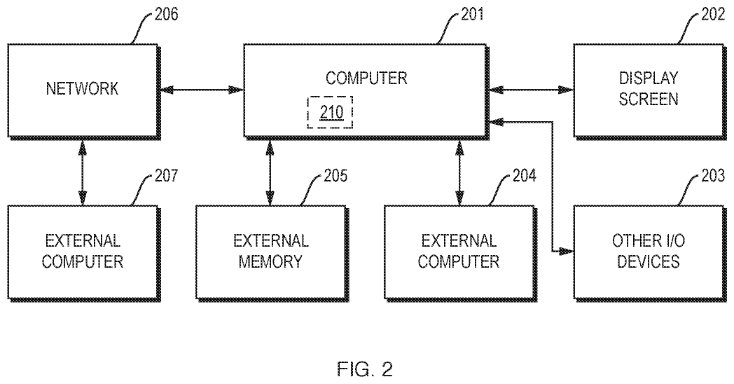

FIG. 2 illustrates hardware, in an illustrative implementation of this invention. In the example shown in FIG. 2, a computer 201 performs machine learning. For instance, computer 201 may: (a) perform calculations that train a neural network with a training corpus; and (b) may, after the neural network is trained, employ the trained neural network to predict one or more visualizations that visually represent the given dataset.

Computer 201 may output instructions that cause an electronic display screen 202 to visually display, to a human user, one or more predicted or recommended visualizations (e.g., charts, plots, or diagrams) of the given dataset.

Computer 201 may also output instructions that cause display screen 202 to display a GUI. In the example shown in FIG. 2, a human user may interact with the GUI via display screen 202 itself (if it is a touch screen) or via one or more other I/O (input/output) devices 203. For instance, I/O devices 203 may comprise one or more keyboards, computer mice, microphones and speakers. A human user may employ the GUI to input instructions, which instruct computer 201 to accept an upload or import of a dataset (which the user wants to be visualized). For example, in response to these instructions, computer may accept data (e.g., in one or more datafiles) from one or more external computers (e.g., 204, 207) or external memory devices (e.g., 205). For instance, external memory device 205 may comprise a thumb drive or external hard drive. Or, for instance, computer 201 may, through a network 206 (e.g., the Internet or any wireless network), upload data from external computer 207. In some cases, a human user employs I/O devices 203 to manually input or edit the dataset to be visualized.

In some cases, computer 203 outputs data that specifies recommended or predicted data visualizations, without instructing that the visualizations be displayed to a human user. For instance, this data may be sent to an external computer (e.g., 204, 207) or to an external memory device (e.g., 205).

In some cases, memory device 210 comprises a hard drive or compact disk. Memory device 210 may store data, such as (a) all or part of a training corpus, (b) weights for a trained neural network; (c) a dataset to be visualized; and (d) one or more predicted or recommended visualizations of a dataset. Computer 201 may cause data to be stored in, or accessed from, memory device 210.

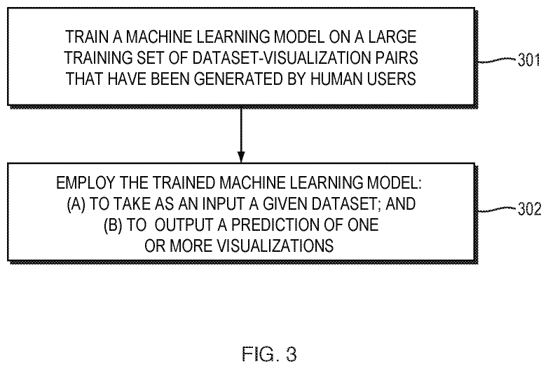

FIG. 3 is a flowchart of a method of data visualization, in an illustrative implementation of this invention. In the example shown in FIG. 3, the method includes at least the following steps: Train a machine learning model on a large training set of dataset-visualization pairs that have been generated by human users (Step 301). Employ the trained machine learning model: (a) to take as an input a given dataset; and (b) to output a prediction of one or more visualizations (Step 302).

### Features and Design Choices

As noted above, in illustrative implementations, a computer extracts features from datasets and extracts design choices from data visualizations.

For instance, during training, features may be extracted from the dataset in each dataset-visualization pair in the training corpus. Also, after a neural network is trained, features may be extracted from a given dataset and based on these features, the trained neural network may predict a visualization (e.g., chart, plot or graph) for the given dataset.

Likewise, during training, design choices may be extracted from the visualization in each dataset-visualization pair in the training corpus. Also, after a neural network is trained, the network may predict a visualization, by outputting design choices that specify the visualization.

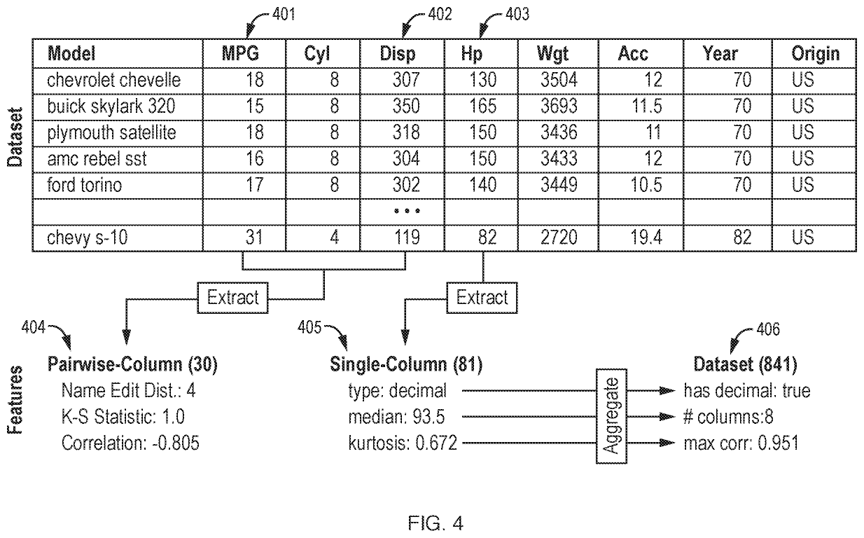

FIG. 4 illustrates features that are extracted from a dataset. In the example shown in FIG. 4, a dataset describes automobile models with eight attributes such as miles per gallon (MPG), horsepower (Hp), and weight in pounds (Wgt). The dataset may be represented by a set of rows and columns, where each row is associated with a particular automobile model (e.g., Chevrolet™ Chevelle™) and each column is associated with a particular attribute (e.g., MPG, Hp, Wgt). For instance, the data in columns 401, 402 and 403 comprises data regarding MPG (miles per gallon), Disp (engine displacement in cubic inches) and Hp (horsepower), respectively.

In the example shown in FIG. 4, a computer extracts, from the dataset, 30 pairwise-column features 404. Specifically, for each pair of columns, the computer extracts a value for each of these 30 pairwise-column features, respectively. In FIG. 4, the pairwise features include (a) correlation; (b) a K. S. (Kolmogorov-Smirnov) value and (c) a raw (un-normalized) edit distance between the column names. For example, in FIG. 4, for the pair of columns consisting of MPG 401 and Disp 402, the extracted pairwise-column values include a correlation of −0.805, a K.S. value of 1.0, and a raw edit distance of 4.

In the example shown in FIG. 4, a computer also extracts, from the dataset, 81 single-column features 405. Specifically, for each column, the computer extracts a value for each of these 81 single-column features, respectively. In FIG. 4, the single-column features include (a) type: decimal; (b) median; and (c) kurtosis. For example, for the Hp column 403, the single-column values extracted by the computer include: (a) type is decimal; (b) median is 93.5; and (c) kurtosis is 0.672. In FIG. 4, the pairwise-column features and single-column-features are aggregated by 16 aggregation functions to create 841 dataset-level features 406.

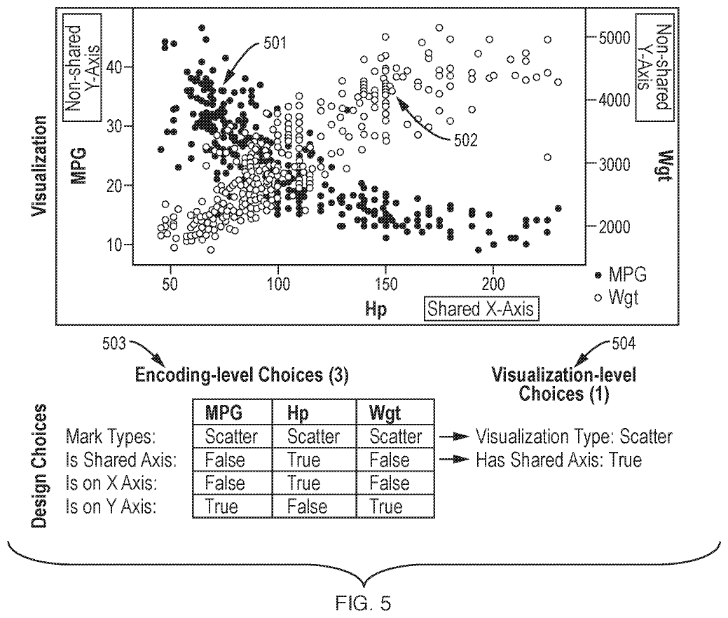

FIG. 5 illustrates design choices that are extracted from a data visualization.

In the data visualization shown in FIG. 5: (a) the x-axis is Hp (horsepower); (b) two variables share the y-axis; (c) the right-side y-axis is Wgt (weight); (d) the left-side y-axis is MPG (miles per gallon); (e) a first scatterplot 501 of dark dots plots MPG (miles per gallon) as a function of Hp (horsepower), and (f) a second scatterplot 502 of hollow dots plots Wgt (weight) as a function of Hp (horsepower).

In FIG. 5, the design choices that are extracted include: (a) encoding-level choices and (b) visualization-level choices. The latter (visualization-level) is a higher-level choice than the former (encoding-level).

In FIG. 5, a computer extracts, from the data visualization, three encoding-level design choices 503. Specifically, for each attribute (MPG, HP and Wgt respectively), the computer extracts a True/False value that specifies whether, in the data visualization, the attribute: (a) shares an axis with another variable; (b) is on the x-axis; or (c) is on the y-axis.

In FIG. 5, a computer also extracts, from the data visualization, one visualization-level design choice 504. This design choice is: the data visualization is a scatterplot with a shared axis.

The number and type of features that are extracted from datasets (e.g. for training or after training) may vary depending on the particular implementation (or use scenario) of this invention. Likewise, the number and type of design choices that are extracted from data visualizations during training—or that are predicted by the VizML system—may vary depending on the particular implementation (or use scenario) of this invention.

For instance, the set of design choices may depend, in part, on: (a) the visualization grammar that is employed; or (b) the color or size of the screen that will display the data visualization. For instance, design choices that are available in Vega-lite grammar may not be available in the grammar employed for Tableau® software. Also, a set of design choices for a color display screen may be different than for a black-and-white display screen. Likewise, a set of design choices for a small mobile screen may be different than for a large computer monitor screen.

Also, which features are extracted (in training or for prediction) may depend on the contemplated use scenario. This is because which features are important, for purposes of predicting a visualization, may vary depending on the use scenario. For instance, different visualization grammars, different types of data, or different types of display screens (e.g., color, black-and-white, mobile, monitor) may make it desirable to extract a different set of features (for training or prediction).

The following three paragraphs set forth a non-exhaustive list of design choices. In some implementations, the design choices that are extracted (during training) or predicted (after training) by a VizML system include one or more of the design choices listed in the following three paragraphs.

These design choices include graphical mark types, such as area (e.g., a filled area), arc, circle, image, line, point, rectangle, rule (e.g., a line segment) and text. These design choices also include visual encodings which depend on the type of visual mark, such as (a) for a filled area, encodings including primary x position, secondary y position, primary y position, secondary y position, fill color, fill opacity, stroke color, stroke opacity and stroke width; (b) for an arc, encodings including start angle, end angle, inner radius and outer radius; (c) for a circle, encodings including x position, y position, radius, fill color, fill opacity, stroke color, stroke opacity and stroke width; (d) for a line, encodings including x position, y position, stroke color, stroke opacity and stroke width; (e) for a point, encodings including x position, y position, fill color, fill opacity, stroke color, stroke opacity and stroke width; (f) for a rectangle, encodings including primary x position, secondary y position, primary y position, secondary y position, fill color, fill opacity, stroke color, stroke opacity and stroke width; (g) for a rule (e.g., a line segment), encodings including x position, y position, stroke color, stroke opacity and stroke width; and (h) for text, encodings including x position, y position, angle, font, font size, font style and font weight. If the dataset being visualized consists of different groups of data (e.g. miles per gallon and weight), the design choices listed in the preceding two sentences may be different for each of the different groups of data.

The design choices that are extracted (during training) or predicted (after training) may also include, for an axis, encodings including domain, range, labels, ticks, titles, and grid. These design choices may also include: (a) conditions, such as predicates used to determine encoding rules; (b) sort order; (c) whether and how to stack visual elements, including whether visual elements start from an absolute position or relative to other elements; (d) scale type, including continuous (e.g., linear, power, or logarithmic); discrete (e.g., ordinal, band, or point), and discretizing (e.g., bin-ordinal, quantile, or threshold); and (e), whether multiple data values are on the same axis, and whether all data values share the same axis.

The design choices may also include higher-level choices such as (a) visualization type, including bar chart, box plot, area chart, line chart, and scatter plot; and (b) view composition, such as faceting (also known as a trellis plot or small multiples) and layering (e.g., superimposing visualizations on top of one another).

The preceding three paragraphs describe non-limiting examples of design choices. This invention may be implemented with other design choices, in addition to or instead of, those listed in the preceding three paragraphs.

In some implementations: (a) each design choice is a set of one or more visual encodings; and (b) each visual encoding is a mapping from a set of data values to visual properties of graphical marks. A design choice may succinctly specify multiple visual encodings.

As noted above, a visual encoding may map from a set of data values to visual properties of graphical marks. For instance, a graphical mark on a two-dimensional plane may be a distinct visual element, which comprises geometrical primitives of points, lines and areas. A blank space (which separates distinct visual elements) may be a region of a two-dimensional plane that is not occupied by a graphical mark. A non-limiting example of a “blank space” is a light-shaded region that is between, and that separates, dark-shaded points.

Here are some non-limiting examples of visual encodings, which may be employed in data visualizations in the present invention: (a) representing daily temperature measurements with the y position of line marks; (b) representing city populations with the size of circle marks centered on the geographical center of a city on a map; and (c) representing the proportion of men and women per age group with the heights of stacked bar marks.

Here are some non-limiting examples of visual properties of a graphical mark, which may be employed in data visualizations in the present invention: x position, y position, size, opacity, texture, color, orientation, and shape.

In illustrative implementations of this invention, data visualization communicates information by representing data with visual elements. These representations may be specified using encodings that map from data to visual properties (e.g., position, length, or color) of graphical marks (e.g., points, lines, or rectangles).

### Prototype

The following 41 paragraphs describe a prototype of this invention.

In this prototype, the training corpus consists of 2.3 million dataset-visualization pairs from the Plotly® Community Feed. These pairs were generated by 143,007 unique users. In this prototype, these 2.3 million dataset-visualization pairs were used to train the VizML system.

In this prototype, each dataset is mapped to 841 features, mapped from 81 single-column features and 30 pairwise-column features using 16 aggregation functions.

In this prototype, each column is described by 81 single-column features across four categories. The Dimensions (D) feature is the number of rows in a column. Types (T) features capture whether a column is categorical, temporal, or quantitative. Values (V) features describe the statistical and structural properties of the values within a column. Names (N) features describe the column name.

In this prototype, each pair of columns is described with 30 pairwise-column features. These features fall into two categories: Values and Names. Note that many pairwise-column features depend on the individual column types determined through single-column categorical columns. For instance, the Pearson correlation coefficient relates to two numeric columns, and “number of shared values” relates to two categorical columns.

In this prototype, 841 dataset-level features are created by aggregating these single- and pairwise-column features using 16 aggregation functions. These aggregation functions convert single-column features (across all columns) and pairwise-column features (across all pairs of columns) into scalar values. For example, given a dataset, the features may include the number of columns, the percent of columns that are categorical, and the mean correlation between all pairs of quantitative columns. Some alternate versions of this prototype: (a) incorporate single-column features that train a separate model for each column, or (b) include column features with padding.

In this prototype, a computer may extract design choices that were made by Plotly® users when creating the training corpus of 2.3 million dataset-visualization pairs. To do so, a computer parses traces that associate collections of data with visual elements in the Plotly® visualizations. For instance, a computer may extract encoding-level design choices such as: (a) mark type (e.g., scatter, line, or bar); or (b) X or Y column encoding (which specifies which column is represented on which axis; and whether or not an X or Y column is the single column represented along that axis).

In this prototype, these encoding-level design choices are aggregated to make visualization-level design choices for a chart. In this prototype, the visualization-level design choices are appropriate for the Plotly® corpus, in which over 90% of the visualizations consist of homogeneous mark types. In this prototype, the visualization type both: (a) describes the type shared among all traces; and (b) specifies whether the visualization has a shared axis.

In this prototype, raw features are converted into a form suitable for modeling using a five-stage pipeline. First, one-hot encoding is applied to categorical features. Second, numeric values that are above the 99th percentile or below the 1st percentile are set to those respective cut-offs. Third, categorical values are imputed using the mode of non-missing values, and missing numeric values are imputed with the mean of non-missing values. Fourth, the mean of numeric fields are removed and scaled to unit variance. Fifth, datasets that are exact duplicates of each other were randomly removed, resulting in unique 1,066,443 datasets and 2,884,437 columns. However, in the Plotly® corpus, many datasets are slight modifications of each other, uploaded by the same user. Therefore, in this prototype, all but one randomly selected dataset per user is removed, which also removed bias towards more prolific Plotly® users. This aggressive deduplication resulted in a final corpus of 119,815 datasets and 287,416 columns.

In this prototype, a model (neural network) is trained to predict design choices, by training on features and design choices that are extracted from the training corpus.

In this prototype, a computer performs two visualization-level prediction tasks. Specifically, a computer predicts (a) the visualization type (e.g., scatterplot, line, bar, box, histogram, or pie) and (b) whether (true/false) the visualization includes an axis that is shared by more than one type of data (e.g., miles per gallon and weight).:

In this prototype, a computer also performs three encoding-level prediction tasks. Specifically, a computer predicts, for a given attribute (e.g. miles per gallon) in the dataset: (a) what type of visual mark (e.g., scatterplot, line, bar, box, histogram, or pie) to use in the visualization represent the given attribute; (b) whether to represent the attribute on a shared axis (e.g., a shared x-axis or shared y-axis) in the visualization; and (c) whether to represent the attribute on the x-axis or y-axis in the visualization. In this prototype, these three encoding-level prediction tasks consider each attribute independently. As noted above, each attribute (e.g., miles per gallon) may correspond to a column in the dataset.

In this prototype: (a) the set of allowed visual mark types (for both visualization type or for encoding-level mark type) consists of either 2, 3 or 6 classes of marks; (b) the 2-class task predicts line vs. bar; (c) the 3-class task predicts scatter vs. line vs. bar; and (d) the 6-class task predicts scatterplot vs. line vs. bar vs. box vs. histogram vs. pie. Although the Plotly® visualization software supports over twenty mark types, this prototype limits prediction outcomes to the few types that comprise the majority of visualizations in the training corpus.

In this prototype, a fully-connected feedforward neural network (NN) is employed. This fully-connected neural network includes 3 hidden layers, each consisting of 1,000 neurons with ReLU (rectified linear unit) activation functions. This neural network is implemented using the PyTorch machine learning library.

In this prototype, the neural network was trained with an Adam optimizer and a mini-batch size of 200. The learning rate was initialized at 5×10⁻⁴, and followed a learning rate schedule that reduces the learning rate by a factor of 10 upon encountering a plateau, defined as 10 epochs during which validation accuracy does not increase beyond a threshold of 10⁻³. Training ended after the third decrease in the learning rate, or at 100 epochs.

In tests of this prototype, four different feature sets were constructed by incrementally adding the Dimensions (D), Types (T), Values (V), and Names (N) categories of features, in that order. We refer to these feature sets as D, D+T, D+T+V, and D+T+V+N=All. The neural network was trained and tested using all four feature sets independently.

In tests of this prototype, the value-based feature set (e.g., the statistical properties of a column) contributed more to performance than the type-based feature set (e.g., whether a column is categorical). This may be because there are many more value-based features than type-based features. Or, since many value-based features are dependent on column type, there may be overlapping information between value- and type-based features.

In tests of this prototype, dimensionality features—such as the length of columns (i.e., the number of rows) or the number of columns—were important for prediction. For instance, in these tests, the length of a column is the second most important feature for predicting whether that column is visualized as a line or bar trace.

In tests of this prototype, features related to column type were important for prediction tasks. For example, in these tests, whether a dataset contains a string type column is the fifth most important feature for determining two-class visualization type.

In tests of this prototype, statistical features (quantitative, categorical) such as Gini, entropy, skewness and kurtosis were important for prediction.

In tests of this prototype, measures of orderedness (i.e., specifically sortedness and monotonicity) were important for many prediction tasks. Sortedness is defined as the element-wise correlation between the sorted and unsorted values of a column, that is |corr(X_{raw}, X_{sorted})|, which lies in the range [0, 1]. Monotonicity is determined by strictly increasing or decreasing values in X_{raw}. The inventors are not aware of any conventional visualization recommender systems that extract orderedness as a feature, for training or prediction.

In tests of this prototype, the linear or logarithmic space sequence coefficients were important for encoding-level prediction tasks. These coefficients may be heuristic-based features that roughly capture the scale of variation. Specifically, the linear space sequence coefficient is determined by std(Y)/mean(Y), where Y={Xᵢ−Xᵢ₋₁} with i=(1+1) . . . N for the linear space sequence coefficient, and Y={Xᵢ/Xᵢ₋₁} with i=(1+1) . . . N for the logarithmic space sequence coefficient. A column “is” linear or logarithmic if its coefficient ≤10⁻³. The inventors are not aware of any conventional visualization recommender systems that extract linear or logarithmic space sequence coefficients as a feature, for training or prediction.

In this prototype, the neural network was trained on a training corpus that included (before data cleaning) 2.3 million dataset-visualization pairs that were created with Plotly® software. For instance, the Plotly® software that created these pairs may include Plotly® Chart Studio, which is a web application that lets users upload datasets and manually create interactive D3.j s and WebGL visualizations of over 20 visualization types. Also, some of the dataset-visualizations in the training corpus were created by users who used the Plotly® Python library to create visualizations with code. The Plotly® visualizations in training corpus were specified with a declarative schema. In this schema, each visualization is specified with two data structures. The first is a list of traces that specify how a collection of data is visualized. The second is a dictionary that specifies aesthetic aspects of a visualization untied from the data, such as axis labels.

In this prototype, the Plotly® API was employed to collect approximately 2.5 years of public visualizations from the Plotly® Community Feed, starting Jul. 17, 2015 and ending Jan. 6, 2018. A total of 2,359,175 visualization were collected for this prototype, 2,102,121 of which contained all three configuration objects, and 1,989,068 of which were parsed without error. To avoid confusion between user-uploaded datasets and our dataset of datasets, we sometimes refer to this collection of dataset-visualization pairs as the Plotly® corpus.

In this prototype, the Plotly® corpus contains visualizations created by 143,007 unique users, who vary widely in their usage. Excluding the top 0.1% of users with the most visualizations, users created a mean of 6.86 and a median of 2 visualizations each.

In this prototype, datasets in the Plotly® corpus also vary widely in number of columns and rows. Though some datasets contain upwards of 100 columns, 94.97% contain less than or equal to 25 columns. Excluding datasets with more than 25 columns, the average dataset has 4.75 columns, and the median dataset has 3 columns. The distribution of rows per dataset has a mean of 3105.97, median of 30, and maximum of 107.

In this prototype, 98.32% of visualizations in the Plotly® corpus used only one source dataset. Therefore, this prototype predicts only visualizations that use a single source dataset.

In this prototype, 81 single-column features, 30 pairwise-column features and 16 aggregation functions are employed. The 81 single-column features fall into four categories: dimensions (number of rows in a column), types (categorical, temporal, or quantitative), values (the statistical and structural properties) and names (related to column name). The 30 pairwise-column features into two categories (values and names). The 841 dataset-level features are created by aggregating these features using 16 aggregation functions.

In this prototype, the 81 single-column features (that are extracted during training and for prediction) describe the dimensions, types, values, and names of individual columns.

In this prototype, the 81 single-column features include dimensions. The dimensions are one feature (specifically, the length, i.e., number of values).

In this prototype, the 81 single-column features also include types. These types are 8 features, including three general types (categorical, quantitative and temporal) and five specific types (string, boolean, integer, decimal, datetime).

In this prototype, the 81 single-column features also include values. These values are 58 features, including: (a) 16 statistical values regarding quantitative or temporal data (mean, median, range times (raw/normalized by max), variance, standard deviation, coefficient of variance, minimum, maximum, (25th/75th) percentile, median absolute deviation, average absolute deviation, and quantitative coefficient of dispersion); (b) 14 distribution values (entropy, Gini, skewness, kurtosis, moments (5-10), normality (statistic, p-value), is normal at (p<0.05, p<0.01); (c) 8 outlier values ((has/%) outliers at (1.5 times IQR, 3 times IQR, 99 percentile, 3 a); (d) 7 statistical values regarding categorical data (entropy, (mean/median) value length, (min, std, max) length of values, % of mode); (e) 7 sequence values (is sorted, is monotonic, sortedness, (linear/log), space sequence coefficient, is (linear/space) space); (f) 3 values regarding uniqueness (is /#/%); and (g) 3 values regarding missing data (has/#/%).

In this prototype, the 81 single-column features also include names. These names are 14 features, including: (a) 4 properties (name length, # words, # uppercase characters, starts with uppercase letter); and (b) 10 values (“x”, “y”, “id”, “time”, digit, whitespace, “£”, “€”, “¥”, in name). In the preceding sentence, “£”, “€”, “¥” are currency symbols for pound sterling, euro and Japanese yen, respectively.

In this prototype, 30 pairwise-column features describe the relationship between values and names of pairs of columns.

In this prototype, the 30 pairwise-column features include values. These values are 25 features, including: (a) 8 values regarding a pair of columns, where both columns in the pair consist of quantitative data (correlation (value, p, p<0.05), Kolmogorov-Smirnov (value, p, p<0.05), (has, %) overlapping range); (b) 6 values regarding a pair of columns, where both columns in the pair consist of categorical data (chi-squared (value, p, p<0.05), nestedness (value, =1, >0.95%); (c) 3 values regarding a pair of columns, where one column consists of categorical data and other column consists of quantitative data (one-Way ANOVA (value, p, p<0.05)).

In this prototype, the 30 pairwise-column features also include shared values. These shared values are 8 features, including is identical, (has/#/%) shared values, unique values are identical, (has/#/%) shared unique values.

In this prototype, the 30 pairwise-column features also include names. These names are 5 features, including: (a) two character features (edit distance (raw/normalized)) and (b) two word features ((Has, #, %) shared words)).

In this prototype, 16 aggregation functions aggregate single- and pairwise-column features into 841 dataset-level features.

In this prototype, the 16 aggregation functions include 5 aggregation functions regarding categories in the dataset (Number (#), percent (%), has, only one (#=1), all).

In this prototype, the 16 aggregation functions also include 10 aggregation functions regarding quantitative data in the dataset (mean, variance, standard deviation, coefficient of variance (CV), min, max, range, normalized range (NR), average absolute deviation (AAD) median absolute deviation (MAD).

In this prototype, the 16 aggregation functions also include one special function (entropy of data types).

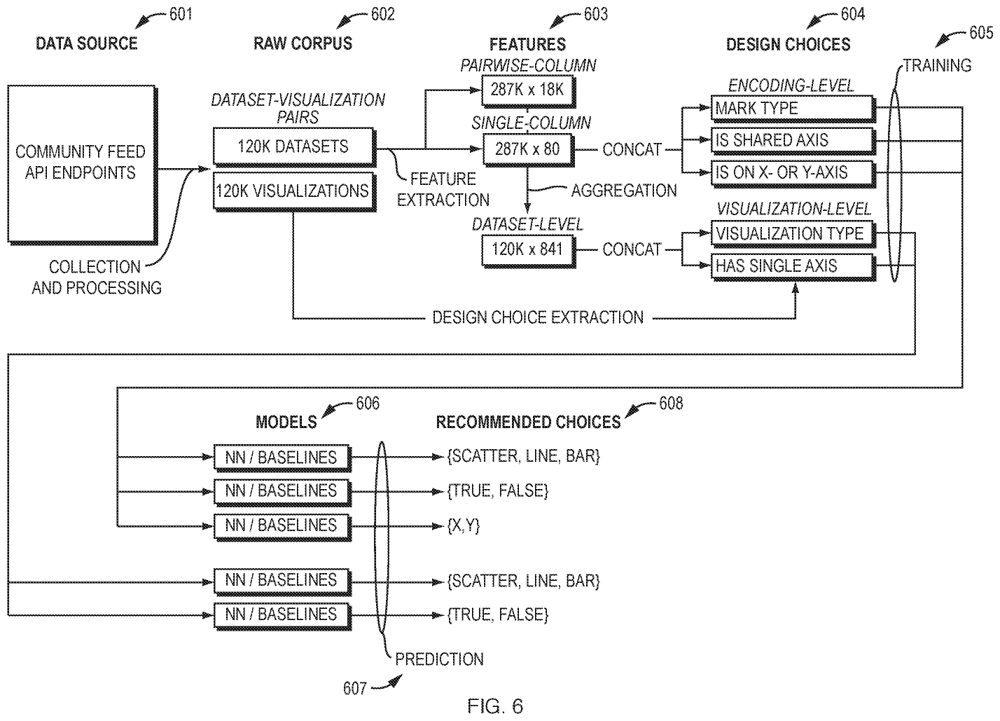

FIG. 6 is flowchart for a method of data visualization that is employed in this prototype. As shown in FIG. 6, in this prototype; (a) the data source 601 comprises community feed API endpoints; (b) the raw corpus 602 comprises dataset-visualization pairs, (c) features 603 are extracted from the datasets in the dataset-visualization pairs in the training corpus; (d) design choices 604 are extracted from the visualizations in the dataset-visualization pairs in the training corpus; (e) a neural network (models 606) undergoes training 605; and (f) the trained neural network makes predictions 607 of design choices 608 to be recommended to a human user.

The prototype described in the preceding 41 paragraphs is a non-limiting example of this invention. This invention may be implemented in many other ways. For instance, this invention: (a) may employ a different training corpus; (b) may collect and clean the training corpus in a different manner; (c) may employ a different type of neural network; (d) may use different hyperparameters of a neural network (e.g., number of layers, type of layers, number of neurons per layer, regularization techniques, and learning rates); (e) may extract different features; (f) may employ different aggregation functions; and (g) may employ a different set of design choices for training and prediction.

### Software

The following nine paragraphs describe 34 software files that (a) are listed in the Computer Program Listing above; and (b) comprise software employed in a prototype of this invention.

In order to file these 34 software files electronically with the U.S. Patent and Trademark Office (USPTO) website, they were altered by: (a) converting them to ASCII .txt format and (b) revising their filenames. To reverse these alterations (and thereby enable these 34 software files to be executed in the same manner as in a prototype of this invention) the following changes may be made: (a) delete “_py.txt” each time that it appears in a filename extension and replace it with “.py”; (b) change the file name “Part_0” to “Part 0—Descriptive Statistics.ipyn”; (c) change the file name “Part_1” to “Part 1—Plotly Performance.ipyn”; (d) change the file name “Part_2” to “Part 2—Model Feature Importances.ipyn”; (e) change the file name “Part_3” to “Part 3—Benchmarking.ipyn”; “(f) change the file name “util2_py.txt” to “util.py”; and (g) change the file name “retrieve data sh.txt” to “retrieve data.sh”.

Also, in order to convert the software file “single field_features.py” to ASCII format (to allow it to be electronically with the USPTO), alterations were made to the code of that file. Specifically, non-ASCII characters were replaced with ASCII text. To reverse these alterations (and thereby enable single_field_features.py to be executed in the same manner as in a prototype of this invention) the code segment (in the single_field_features program) which reads

r[‘pound_in_name’]=(‘GBP’ in n)

r[‘euro_in_name’]=(‘EUR’ in n)

r[‘yen_in_name’]=(‘JPY’ in n)

may be replaced with the code segment

r[‘pound_in_name’]=(‘Â£’ in n)

r[‘euro_in_name’]=(‘â,¬’ in n)

r[‘yen_in_name’]=(‘Â [symbol] ’ in n)

Some of the software involves data cleaning. For instance: (a) deduplicate_charts.py removes all but one randomly chosen chart per Plotly user; and (b) remove_charts_without_all_data.py removes charts without source and layout data.

Some of the software involves feature extraction. For instance: (a) aggregate_single_field_features.py aggregates single-column features; (b) aggregation_helper.py includes helper functions used in aggregate_single_field_features.py; (c) dateparser.py detects and marks dates; (d) helpers.py includes helper functions used in feature extraction scripts; (e) single_field_features.py extracts single-column features; (f) transform.py transforms single-column features; (g) type_detection.py detects data types; (h) chart_outcomes.py extracts design choices of visualizations; (i) field_encoding_outcomes.py extracts design choices of encodings; (j) extract.py comprises a top-level entry point to extract features and outcomes; and (k) general_helpers.py includes helpers used in top-level extraction function.

Some of the software files include helper functions. For instance: (a) analysis.py includes helper functions used when training baseline models; (b) processing.py includes helper functions used when processing data; and (c) util.py (after its filename is changed from util2_py.txt as described above) includes miscellaneous helper functions.

Some of the software involves a neural network. For instance: (a) agg.py comprises a top-level entry point to load features and train a neural network; (b) evaluate.py evaluates a trained neural network; (c) nets.py includes class definitions for a neural network; (d) paper_ground_truth.py evaluates best network against benchmarking ground truth; (e) paper tasks.py evaluates the best network for a Plotly® test set; (f) save_field.py prepares training, validation, and testing splits; (g) train.py includes helper functions for model training; (h) train_field.py trains a neural network; and (i) util.py includes helper functions.

Some of the software involves notebooks. For instance: (a) Part 0—Descriptive Statistics.ipynb comprises a notebook to generate visualizations of number of charts per user, number of rows per dataset, and number of columns per dataset; (b) Part 1—Plotly Performance.ipynb comprises a notebook to train baseline models and assess performance on a hold-out set from the Plotly® corpus; (c) Part 2—Model Feature Importances comprises a notebook to extract feature importances from trained models; and (d) Part 3—Benchmarking.ipynb comprises a notebook to generate predictions of trained models on benchmarking datasets, bootstrap crowdsourced consensus, and compare predictions.

Some of the software involves preprocessing. For instance: (a) deduplication.py includes helper functions to deduplicate charts; (b) impute.py includes a helper function to impute missing values; and (c) preprocess.py includes helper functions to prepare features for learning.

The program retrieve_data.sh retrieves Plotly® data from an Amazon® S3 dump. And requirements.txt includes Python® dependencies.

The 34 software files described in the preceding nine paragraphs are a non-limiting example of software that may be employed in this invention. This invention is not limited to that software. Other software may be employed. Depending on the particular implementation, the software used in this invention may vary.

### Computers

In illustrative implementations of this invention, one or more computers (e.g., servers, network hosts, client computers, integrated circuits, microcontrollers, controllers, field-programmable-gate arrays, personal computers, digital computers, driver circuits, or analog computers) are programmed or specially adapted to perform one or more of the following tasks: (1) to control the operation of, or interface with, hardware components of a visualization recommender system, including any display screen and any other input/output device; (2) to extract features from datasets; (3) to extract design choices from visualizations; (4) to train a machine learning model, such as a neural network, on a training corpus that comprises dataset-visualization pairs; (5) given a dataset, to predict a visualization that represents the dataset; (6) to recommend, and to rank, multiple visualizations for a given dataset; (7) to learn preferences of an individual user and to make customized recommendations for that user; (8) to output instructions to visually display a data visualization; (9) to receive data from, control, or interface with one or more sensors; (10) to perform any other calculation, computation, program, algorithm, or computer function described or implied herein; (11) to receive signals indicative of human input; (12) to output signals for controlling transducers for outputting information in human perceivable format; (13) to process data, to perform computations, and to execute any algorithm or software; and (14) to control the read or write of data to and from memory devices (tasks 1-14 of this sentence being referred to herein as the “Computer Tasks”). The one or more computers (e.g., 201) may, in some cases, communicate with each other or with other devices: (a) wirelessly, (b) by wired connection, (c) by fiber-optic link, or (d) by a combination of wired, wireless or fiber optic links.

In exemplary implementations, one or more computers are programmed to perform any and all calculations, computations, programs, algorithms, computer functions and computer tasks described or implied herein. For example, in some cases: (a) a machine-accessible medium has instructions encoded thereon that specify steps in a software program; and (b) the computer accesses the instructions encoded on the machine-accessible medium, in order to determine steps to execute in the program. In exemplary implementations, the machine-accessible medium may comprise a tangible non-transitory medium. In some cases, the machine-accessible medium comprises (a) a memory unit or (b) an auxiliary memory storage device. For example, in some cases, a control unit in a computer fetches the instructions from memory.

In illustrative implementations, one or more computers execute programs according to instructions encoded in one or more tangible, non-transitory, computer-readable media. For example, in some cases, these instructions comprise instructions for a computer to perform any calculation, computation, program, algorithm, or computer function described or implied herein. For example, in some cases, instructions encoded in a tangible, non-transitory, computer-accessible medium comprise instructions for a computer to perform the Computer Tasks.

### Computer Readable Media

In some implementations, this invention comprises one or more computers that are programmed to perform one or more of the Computer Tasks.

In some implementations, this invention comprises one or more tangible, non-transitory machine readable media, with instructions encoded thereon for one or more computers to perform one or more of the Computer Tasks.

In some implementations, this invention comprises participating in a download of software, where the software comprises instructions for one or more computers to perform one or more of the Computer Tasks. For instance, the participating may comprise (a) a computer providing the software during the download, or (b) a computer receiving the software during the download.

### Network Communication

In illustrative implementations of this invention, electronic devices (e.g., 201, 203, 204, 206, 207) are each configured for wireless or wired communication with other devices in a network.

For example, in some cases, one or more of these electronic devices each include a wireless module for wireless communication with other devices in a network. Each wireless module may include (a) one or more antennas, (b) one or more wireless transceivers, transmitters or receivers, and (c) signal processing circuitry. Each wireless module may receive and transmit data in accordance with one or more wireless standards.

In some cases, one or more of the following hardware components are used for network communication: a computer bus, a computer port, network connection, network interface device, host adapter, wireless module, wireless card, signal processor, modem, router, cables or wiring.

In some cases, one or more computers (e.g., 201, 204, 207) are programmed for communication over a network. For example, in some cases, one or more computers are programmed for network communication: (a) in accordance with the Internet Protocol Suite, or (b) in accordance with any other industry standard for communication, including any USB standard, ethernet standard (e.g., IEEE 802.3), token ring standard (e.g., IEEE 802.5), or wireless communication standard, including IEEE 802.11 (Wi-Fi®), IEEE 802.15 (Bluetooth®/Zigbee®), IEEE 802.16, IEEE 802.20, GSM (global system for mobile communications), UMTS (universal mobile telecommunication system), CDMA (code division multiple access, including IS-95, IS-2000, and WCDMA), LTE (long term evolution), or 5G (e.g., ITU IMT-2020).

### Definitions

The terms “a” and “an”, when modifying a noun, do not imply that only one of the noun exists. For example, a statement that “an apple is hanging from a branch”: (i) does not imply that only one apple is hanging from the branch; (ii) is true if one apple is hanging from the branch; and (iii) is true if multiple apples are hanging from the branch.

To compute “based on” specified data means to perform a computation that takes the specified data as an input.

The term “comprise” (and grammatical variations thereof) shall be construed as if followed by “without limitation”. If A comprises B, then A includes B and may include other things.

A digital computer is a non-limiting example of a “computer”. An analog computer is a non-limiting example of a “computer”. A computer that performs both analog and digital computations is a non-limiting example of a “computer”. However, a human is not a “computer”, as that term is used herein.

“Computer Tasks” is defined above.

A non-limiting example of a human “creating” a visualization (which represents a specific dataset) is a human employing software (a) to input design choices made by the human regarding how to visually represent the specific dataset, and (b) to implement the design choices to generate the visualization.

“Dataset-visualization pair” means a pair that consists of (i) a dataset and (ii) a visualization that represents the dataset.

To say that a visualization is “defined” by design choices means that the design choices at least partially specify the visualization.

“Defined Term” means a term or phrase that is set forth in quotation marks in this Definitions section.

For an event to occur “during” a time period, it is not necessary that the event occur throughout the entire time period. For example, an event that occurs during only a portion of a given time period occurs “during” the given time period.

To say that “each” X in a group of Xs consists of a Y means each of the Xs, respectively, consists of a Y. As a non-limiting example, if “each” X in a group of Xs consists of a pair, then each X may be a different pair.

To “extract” X from Y means to calculate X based on Y.

The term “e.g.” means for example.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, respectively, so that they each may be referred to later with specificity (e.g., by referring to “the first” thing and “the second” thing later). For example, unless the context clearly indicates otherwise, if an equation has a first term and a second term, then the equation may (or may not) have more than two terms, and the first term may occur before or after the second term in the equation. A phrase that includes a “third” thing, a “fourth” thing and so on shall be construed in like manner.

“For instance” means for example.

A non-limiting example of extracting features and design choices “from a training corpus” is extracting the features from datasets in the training corpus and extracting the design choices from visualizations in the training corpus.

To say a “given” X is simply a way of identifying the X, such that the X may be referred to later with specificity. To say a “given” X does not create any implication regarding X. For example, to say a “given” X does not create any implication that X is a gift, assumption, or known fact.

“Herein” means in this document, including text, specification, claims, abstract, and drawings.

As used herein: (1) “implementation” means an implementation of this invention; (2) “embodiment” means an embodiment of this invention; (3) “case” means an implementation of this invention; and (4) “use scenario” means a use scenario of this invention.

The term “include” (and grammatical variations thereof) shall be construed as if followed by “without limitation”.

A non-limiting example of a “majority” of Xs is all of the Xs.

Unless the context clearly indicates otherwise, “or” means and/or. For example, A or B is true if A is true, or B is true, or both A and B are true. Also, for example, a calculation of A or B means a calculation of A, or a calculation of B, or a calculation of A and B.

A parenthesis is simply to make text easier to read, by indicating a grouping of words. A parenthesis does not mean that the parenthetical material is optional or may be ignored.

As used herein, the term “set” does not include a group with no elements.

Unless the context clearly indicates otherwise, “some” means one or more.

As used herein, a “subset” of a set consists of less than all of the elements of the set.

The term “such as” means for example.

“Training corpus” means a training dataset. For instance, a training corpus may comprise multiple dataset-visualization pairs.

To say that a machine-readable medium is “transitory” means that the medium is a transitory signal, such as an electromagnetic wave.

“VizML system” or “visualization recommender system” means a system that recommends (or predicts) a visualization which visually represents a dataset. For instance, the visualization may be all or part of a chart, plot or diagram.

“Visualization” means a visual representation of a dataset.

To predict “with” a neural network means that the neural network makes the prediction.

Except to the extent that the context clearly requires otherwise, if steps in a method are described herein, then the method includes variations in which: (1) steps in the method occur in any order or sequence, including any order or sequence different than that described herein; (2) any step or steps in the method occur more than once; (3) any two steps occur the same number of times or a different number of times during the method; (4) any combination of steps in the method is done in parallel or serially; (5) any step in the method is performed iteratively; (6) a given step in the method is applied to the same thing each time that the given step occurs or is applied to a different thing each time that the given step occurs; (7) one or more steps occur simultaneously; or (8) the method includes other steps, in addition to the steps described herein.

Headings are included herein merely to facilitate a reader's navigation of this document. A heading for a section does not affect the meaning or scope of that section.

This Definitions section shall, in all cases, control over and override any other definition of the Defined Terms. The Applicant or Applicants are acting as his, her, its or their own lexicographer with respect to the Defined Terms. For example, the definitions of Defined Terms set forth in this Definitions section override common usage and any external dictionary. If a given term is explicitly or implicitly defined in this document, then that definition shall be controlling, and shall override any definition of the given term arising from any source (e.g., a dictionary or common usage) that is external to this document. If this document provides clarification regarding the meaning of a particular term, then that clarification shall, to the extent applicable, override any definition of the given term arising from any source (e.g., a dictionary or common usage) that is external to this document. Unless the context clearly indicates otherwise, any definition or clarification herein of a term or phrase applies to any grammatical variation of the term or phrase, taking into account the difference in grammatical form. For example, the grammatical variations include noun, verb, participle, adjective, and possessive forms, and different declensions, and different tenses.

### Variations

This invention may be implemented in many different ways. Here are some non-limiting examples:

In some implementations, this invention is a method comprising: (a) extracting features and design choices from a training corpus, wherein (i) the training corpus comprises dataset-visualization pairs, (ii) each of the pairs, respectively, comprises a dataset and a visualization that represents the dataset, (iii) the extracting is performed in such a way that, for each specific dataset-visualization pair in the training corpus, features are extracted from the dataset in the specific pair and design choices are extracted from the visualization in the specific pair; and (iv) each particular pair, in at least a majority of pairs in the training corpus, consists of a particular visualization that represents a particular dataset, which particular visualization is defined by design choices that were made by a human while creating the particular visualization; (b) training a neural network on the features and the design choices extracted from the training corpus; and (c) after the training, taking a given dataset as an input and predicting, with the neural network, a visualization that represents the given dataset. In some cases, the predicting involves predicting design choices that a human would make to visually represent the given dataset. In some cases, the creating involved the human using software to upload and implement the design choices that were made by the human during the creating. In some cases, the visualization that represents the given dataset comprises all or part of a chart, plot or diagram. In some cases, the method further comprises visually displaying, or causing to be visually displayed, the visualization that represents the given dataset. In some cases, the neural network comprises a convolutional neural network. In some cases, the neural network predicts multiple visualizations for the given dataset. In some cases, the method further comprises: (a) predicting, with the neural network, multiple visualizations for the given dataset; and (b) ranking the multiple visualizations. In some cases, the method further comprises: (a) predicting, with the neural network, multiple visualizations for the given dataset; (b) visually displaying, or causing to be visually displayed, the multiple visualizations; and (c) accepting input from a human regarding the human's selection of a visualization that is one of the multiple visualizations. In some cases, the method further comprises: (a) gathering data about preferences of a specific human regarding visualizations; and (b) predicting, based in part on the preferences, a visualization that the specific human would create to represent the given dataset. Each of the cases described above in this paragraph is an example of the method described in the first sentence of this paragraph, and is also an example of an embodiment of this invention that may be combined with other embodiments of this invention.

In some implementations, this invention is an apparatus comprising one or more computers that are programmed to perform the operations of: (a) extracting features and design choices from a training corpus, wherein (i) the training corpus comprises dataset-visualization pairs, (ii) each of the pairs, respectively, comprises a dataset and a visualization that represents the dataset, (iii) the extracting is performed in such a way that, for each specific dataset-visualization pair in the training corpus, features are extracted from the dataset in the specific pair and design choices are extracted from the visualization in the specific pair; and (iv) each particular pair, in at least a majority of pairs in the training corpus, consists of a particular visualization that represents a particular dataset, which particular visualization is defined by design choices that were made by a human while creating the particular visualization; (b) training a neural network on the features and the design choices extracted from the training corpus; and (c) after the training, taking a given dataset as an input and predicting, with the neural network, a visualization that represents the given dataset. In some cases, the one or more computers are programmed to perform the predicting in such a way as to predict design choices that a human would make to visually represent the given dataset. In some cases, the visualization that represents the given dataset comprises all or part of a chart, plot or diagram. In some cases, the one or more computers are further programmed to output instructions for visually displaying the visualization that represents the given dataset. In some cases, the one or more computers are programmed to predict multiple visualizations for the given dataset. In some cases, the one or more computers are programmed: (a) to predict, with the neural network, multiple visualizations for the given dataset; and (b) to rank the multiple visualizations. In some cases, the one or more computers are programmed: (a) to predict, with the neural network, multiple visualizations for the given dataset; (b) to output instructions for visually displaying the multiple visualizations; and (c) to accept input from a human regarding the human's selection of a visualization that is one of the multiple visualizations. In some cases, the one or more computers are programmed: (a) to gather data about preferences of a specific human regarding visualizations; and (b) to predict, based in part on the preferences, a visualization that the specific human would create to represent the given dataset. Each of the cases described above in this paragraph is an example of the apparatus described in the first sentence of this paragraph, and is also an example of an embodiment of this invention that may be combined with other embodiments of this invention.

In some implementations, this invention is a system comprising: (a) one or more computers; and (b) one or more electronic display screens; wherein the one or more computers are programmed to perform the operations of (i) extracting features and design choices from a training corpus, wherein (A) the training corpus comprises dataset-visualization pairs, (B) each of the pairs, respectively, comprises a dataset and a visualization that represents the dataset, (C) the extracting is performed in such a way that, for each specific dataset-visualization pair in the training corpus, features are extracted from the dataset in the specific pair and design choices are extracted from the visualization in the specific pair; and (D) each particular pair, in at least a majority of pairs in the training corpus, consists of a particular visualization that represents a particular dataset, which particular visualization is defined by design choices that were made by a human while creating the particular visualization, (ii) training a neural network on the features and the design choices extracted from the training corpus, (iii) after the training, taking a given dataset as an input and predicting, with the neural network, a visualization that represents the given dataset, and (iv) outputting instructions to cause the one or more display screens to display the visualization that represents the given dataset. In some cases, the one or more computers are programmed to perform the predicting in such a way as to predict design choices that a human would make to visually represent the given dataset. Each of the cases described above in this paragraph is an example of the system described in the first sentence of this paragraph, and is also an example of an embodiment of this invention that may be combined with other embodiments of this invention.

Each description herein (or in the Provisional) of any method, apparatus or system of this invention describes a non-limiting example of this invention. This invention is not limited to those examples, and may be implemented in other ways.

Each description herein (or in the Provisional) of any prototype of this invention describes a non-limiting example of this invention. This invention is not limited to those examples, and may be implemented in other ways.

Each description herein (or in the Provisional) of any implementation, embodiment or case of this invention (or any use scenario for this invention) describes a non-limiting example of this invention. This invention is not limited to those examples, and may be implemented in other ways.

Each Figure, diagram, schematic or drawing herein (or in the Provisional) that illustrates any feature of this invention shows a non-limiting example of this invention. This invention is not limited to those examples, and may be implemented in other ways.

The above description (including without limitation any attached drawings and figures) describes illustrative implementations of the invention. However, the invention may be implemented in other ways. The methods and apparatus which are described herein are merely illustrative applications of the principles of the invention. Other arrangements, methods, modifications, and substitutions by one of ordinary skill in the art are also within the scope of the present invention. Numerous modifications may be made by those skilled in the art without departing from the scope of the invention. Also, this invention includes without limitation each combination and permutation of one or more of the items (including hardware, hardware components, methods, processes, steps, software, algorithms, features, or technology) that are described herein.

What is claimed:

1. A method comprising:
(a) extracting features and design choices from a training corpus, wherein (i) the training corpus comprises dataset-visualization pairs, (ii) each of the pairs, respectively, comprises a dataset and a visualization that represents the dataset, (iii) the extracting is performed in such a way that, for each specific dataset-visualization pair in the training corpus, features are extracted from the dataset in the specific pair and design choices are extracted from the visualization in the specific pair; and (iv) each particular pair, in at least a majority of pairs in the training corpus, consists of a particular visualization that represents a particular dataset, which particular visualization is defined by design choices that were made by a human while creating the particular visualization;
(b) training a neural network on the features and the design choices extracted from the training corpus; and
(c) after the training, taking a given dataset as an input and predicting, with the neural network, a visualization that represents the given dataset.

2. The method of claim 1, wherein the predicting involves predicting design choices that a human would make to visually represent the given dataset.

3. The method of claim 1, wherein the creating involved the human using software to upload and implement the design choices that were made by the human during the creating.

4. The method of claim 1, wherein the visualization that represents the given dataset comprises all or part of a chart, plot or diagram.

5. The method of claim 1, wherein the method further comprises visually displaying, or causing to be visually displayed, the visualization that represents the given dataset.

6. The method of claim 1, wherein the neural network comprises a convolutional neural network.

7. The method of claim 1, wherein the neural network predicts multiple visualizations for the given dataset.

8. The method of claim 1, wherein the method further comprises:
(a) predicting, with the neural network, multiple visualizations for the given dataset; and
(b) ranking the multiple visualizations.

9. The method of claim 1, wherein the method further comprises:
(a) predicting, with the neural network, multiple visualizations for the given dataset;
(b) visually displaying, or causing to be visually displayed, the multiple visualizations; and
(c) accepting input from a human regarding the human's selection of a visualization that is one of the multiple visualizations.

10. The method of claim 1, wherein the method further comprises:
(a) gathering data about preferences of a specific human regarding visualizations; and
(b) predicting, based in part on the preferences, a visualization that the specific human would create to represent the given dataset.

11. An apparatus comprising one or more computers that are programmed to perform the operations of:
(a) extracting features and design choices from a training corpus, wherein (i) the training corpus comprises dataset-visualization pairs, (ii) each of the pairs, respectively, comprises a dataset and a visualization that represents the dataset, (iii) the extracting is performed in such a way that, for each specific dataset-visualization pair in the training corpus, features are extracted from the dataset in the specific pair and design choices are extracted from the visualization in the specific pair; and (iv) each particular pair, in at least a majority of pairs in the training corpus, consists of a particular visualization that represents a particular dataset, which particular visualization is defined by design choices that were made by a human while creating the particular visualization;
(b) training a neural network on the features and the design choices extracted from the training corpus; and
(c) after the training, taking a given dataset as an input and predicting, with the neural network, a visualization that represents the given dataset.

12. The apparatus of claim 11, wherein the one or more computers are programmed to perform the predicting in such a way as to predict design choices that a human would make to visually represent the given dataset.

13. The apparatus of claim 11, wherein the visualization that represents the given dataset comprises all or part of a chart, plot or diagram.

14. The apparatus of claim 11, wherein the one or more computers are further programmed to output instructions for visually displaying the visualization that represents the given dataset.

15. The apparatus of claim 11, wherein the one or more computers are programmed to predict multiple visualizations for the given dataset.

16. The apparatus of claim 11, wherein the one or more computers are programmed:
(a) to predict, with the neural network, multiple visualizations for the given dataset; and
(b) to rank the multiple visualizations.

17. The apparatus of claim 11, wherein the one or more computers are programmed:
(a) to predict, with the neural network, multiple visualizations for the given dataset;
(b) to output instructions for visually displaying the multiple visualizations; and
(c) to accept input from a human regarding the human's selection of a visualization that is one of the multiple visualizations.

18. The apparatus of claim 11, wherein the one or more computers are programmed:
(a) to gather data about preferences of a specific human regarding visualizations; and
(b) to predict, based in part on the preferences, a visualization that the specific human would create to represent the given dataset.

19. A system comprising:
(a) one or more computers; and
(b) one or more electronic display screens;
wherein the one or more computers are programmed to perform the operations of
(i) extracting features and design choices from a training corpus, wherein (A) the training corpus comprises dataset-visualization pairs, (B) each of the pairs, respectively, comprises a dataset and a visualization that represents the dataset, (C) the extracting is performed in such a way that, for each specific dataset-visualization pair in the training corpus, features are extracted from the dataset in the specific pair and design choices are extracted from the visualization in the specific pair; and (D) each particular pair, in at least a majority of pairs in the training corpus, consists of a particular visualization that represents a particular dataset, which particular visualization is defined by design choices that were made by a human while creating the particular visualization,
(ii) training a neural network on the features and the design choices extracted from the training corpus,
(iii) after the training, taking a given dataset as an input and predicting, with the neural network, a visualization that represents the given dataset, and
(iv) outputting instructions to cause the one or more display screens to display the visualization that represents the given dataset.

20. The system of claim 19, wherein the one or more computers are programmed to perform the predicting in such a way as to predict design choices that a human would make to visually represent the given dataset.
